(19) United States
(12) Patent Application Publication
(10) Pub. No.: US 2008/0288397 A1
(43) Pub. Date: Nov. 20, 2008

(54) Systems and Methods For Updating Remittance Data For Payees

(75) Inventor: Roy Alan Southard, West Liberty, OH (US)

Correspondence Address: SUTHERLAND II, SUTHERLAND, ASBILL & BRENNAN, LLC, 999 PEACHTREE STREET, ATLANTA, GA, 30309, US

(73) Assignee: CheckFree Corporation, Norcross, GA (US)

(21) Appl. No.: 11/749,532

(22) Filed: May 16, 2007

(51) Int. Cl. G06Q 10/00; G06F 17/30; G06Q 40/00

(52) U.S. Cl. 705/39; 705/1; 707/104.1

(57) ABSTRACT

Systems and methods for updating remittance information associated with a payee are disclosed, where a service provider receives updated remittance information associated with a payee and identifies a database entry associated with the payee that includes preexisting remittance information. The updated remittance information is then stored in association with the database entry as a potential replacement for the preexisting remittance information. A determination is then made as to whether a threshold value has been reached, where the threshold value is associated with a count of the number of times the updated remittance information has been previously received. Upon determining the threshold value has been reached, the preexisting remittance information is replaced with the updated remittance information in the database. The remittance information may include a payee's address or other information useful in directing a payment to the payee.

### FIELD OF THE INVENTION

The invention relates generally to bill payment systems and methods, and more particularly, to a set of bill payment system enhancements for more timely and effective processing of payee-specific remittance information changes associated with managed and/or unmanaged payees.

### BRIEF DESCRIPTION OF DRAWINGS

Reference will now be made to the accompanying drawings, which are not necessarily drawn to scale, and wherein:

FIG. 1 is an overall system diagram of a bill payment system implementing both the managed payee and unmanaged payee remittance information update in accordance with an embodiment of the invention

FIG. 2 is a diagram of a payment service provider computing system in accordance with an embodiment of the invention.

FIG. 3 shows an user interface for payee set-up and/or modification in accordance with an embodiment of the invention.

FIG. 4 is a flowchart directed to creating a new unmanaged payee database from a preexisting database in accordance with an embodiment of the invention.

FIG. 5 is a flowchart of the overall process for determining when a global change of address for an established payee is necessary when receiving an address modification request in accordance with an embodiment of the invention.

FIG. 6 is a flowchart directed to the processing of a subscriber-supplied managed payee address that does not match the previously known address stored in the corresponding managed payee database entry in accordance with an embodiment of the invention.

FIG. 7 is a flowchart directed to the processing of a subscriber-supplied unmanaged payee address that does not match the previously known address stored in the corresponding unmanaged payee database entry in accordance with an embodiment of the invention.

FIG. 8 is a flowchart directed to the processing of a new payee address when a subscriber adds a new payee in accordance with an embodiment of the invention.

FIG. 9 is a flowchart directed to the processing of a change of address provided by a third party service, such as the United States Postal Service, in accordance with an embodiment of the invention.

### DETAILED DESCRIPTION OF THE INVENTION

According to an embodiment of the invention described herein, payee address changes are processed in such a way as to leverage “good” changes as soon and as broadly as possible, thereby minimizing mis-deliveries, late payments, and problem resolution efforts. Embodiments of the invention are described below with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory to together constitute an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by special purpose hardware-based computer systems that perform the specified functions or steps, or combinations of special purpose hardware and computer instructions.

The inventions may be implemented through one or more application programs running on one or more operating systems of one or more computers. The inventions also may be practiced with other computer system configurations, including hand-held devices, multiprocessor systems, microprocessor based or programmable consumer electronics, mini-computers, mainframe computers, etc.

Application programs may include software modules, routines, components, objects, data structures, etc. that implement certain abstract data types or perform certain actions or tasks. In a distributed computing environment, the application program (in whole or in part) may be located in local memory, or in other storage. In addition, or in the alternative, the afore-mentioned components that make up the application program (in whole or in part) may be co-resident or distributed (e.g., linked through a communications network) with regard to either storage or execution to allow for the practice of the inventions. Several embodiments of the invention are more fully described hereinafter with reference to the accompanying drawings, in which like numerals indicate like elements throughout the several drawings. Indeed, these inventions may be embodied in many different forms and should not be construed as limited to the embodiments set forth herein; rather, these embodiments are provided so that this disclosure will satisfy applicable legal requirements.

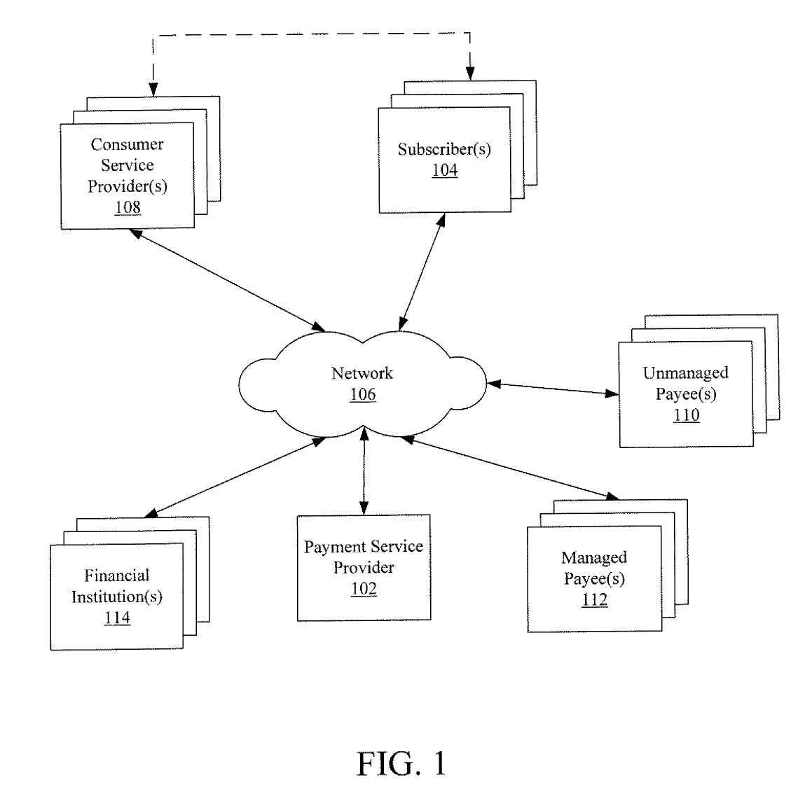

FIG. 1 is an overall system diagram of a bill payment system implementing the unmanaged and managed payee remittance information update in accordance with an embodiment of the invention. Managed payees 112 are entities with which a payment service provider 102 has an ongoing remittance relationship. In an example of an embodiment of the invention, the payment service provider 102 is privy to additional information about the managed payees 112. For example, the payment service provider 102 may know about a payee's multiple remittance centers and which remittance center should be sent remittance advice electronically and under what conditions. The payment service provider 102 may also know the managed payee's 112 deposit account(s) for paying electronically through the Automated Clearinghouse (ACH), or the payment service provider 102 may know the appropriate data formatting for transmission to a payee's electronic payment processing system so a payment may be processed most efficiently by the payee. A large number of remaining payees are known as “unmanaged payees” 110. In an example of an embodiment of the invention, the payment service provider 102 has no remittance relationship with unmanaged payees 110 and does not know anything about them beyond what information is provided from a payment service provider 102 user (also known as a subscriber 104) in a remittance request. From a data repository perspective, subscribers 104 may each have lists of associated payees or “payee lists entries” which may contain both managed 112 and unmanaged payees 110. Information relating to managed payees (also referred to as “authority information” is kept in a managed merchant database or “authority” database).

FIG. 1 depicts a payment service provider 102 capable of providing at least an electronic payment service to a payor also referred to as a “subscriber” 104 of the payment service provider 102. A payment service provider 102 may receive remittance information (e.g., remittance center name, remittance center address, etc.) changes for payees from a variety of sources, sometimes proactively and/or periodically and sometimes only after a problem has occurred using outdated remittance information. The payment service provider must then determine what to do with the received changes and process them accordingly. In alternative embodiments of the invention, the payment service provider 102 may also provide an electronic bill presentment service, as well as other electronic commerce services. Thus, the payment service provider 102 is at least an electronic payment service provider and may also be an electronic billing and payment service provider.

The payment service provider 102 provides the payment service to one or more subscribers 104. Subscribers 104 communicate with the payment service provider 102 via a network 106. The network 106 may be, for example, the Internet though it could be another public network or even a private network. Further, the network 106 could be multiple networks. For simplicity, only one network is shown in FIG. 1 between all the entities, but there could be one network 106 between subscribers 104 and the payment service provider 102 and a different network between the payment service provider and payees. In such a scenario, the plurality of networks need not be “interconnected.”

A subscriber 104, in some instances, communicates directly with the payment service provider 102. In other instances, a subscriber 104 communicates with the payment service provider 102 through one of consumer service providers 108. A consumer service provider 108 is an entity that offers a payment service directly to certain subscribers 104, while the payment service provider 102 provides some supporting functionality, i.e., payment processing and remittance issuance, of completing payments. A consumer service provider 108 may also be referred to as a sponsor. A consumer service provider 108 may present a payment service user interface to a subscriber 104 to provide information to, and receive information from, a subscriber 104. Such a consumer service provider 108 receives information from the payment service provider 102, via the network 106, and then presents such information to a subscriber 104. Likewise in such instances, a consumer service provider 108 receives information from a subscriber 104, and then passes such to the payment service provider 102 via the network 106. Communications between a subscriber 104 and a consumer service provider 108 can, as desired, be via the network 106, via another network, or otherwise. In other situations in which a consumer service provider 108 offers payment services, the payment service provider 102 provides a payment service user interface (UI) directly to a subscriber 104, via the network 106, that is branded as belonging to a consumer service provider 108. It is also possible that, at least for some subset of subscribers 104, the payment service provider 102 fully encompasses the role of consumer service provider (i.e., not only presents the UI, but the contractual relationship with the subscriber is with the service provider and the UI is branded as belonging to the service provider.)

FIG. 1 also depicts one or more managed payees 112. A managed payee 112 is a payee about whom the payment service provider 102 maintains remittance information, where a relationship between the payment service provider 102 and managed payee 112 exists and the managed payee 112 may provide updates to the stored payee remittance information, or alternatively, the payment service provider 102 may initiate an update to the stored payee remittance information. An active relationship between the payment service provider 102 and managed payee 112 enables remittance to that managed payee to be handled in some improved and/or optimal fashion, such as electronically via the network 106 and/or via another network. In other words, a managed payee is one with whom the service provider has a formal relationship, in which the payee provides remittance information to the service provider. It is not required that each managed payee communicate via the network 106, or via any other network.

The remittance information for a managed payee may include one or more account schemes and/or account formats utilized for Accounts Receivable posting at the managed payee 112, account number ranges used for remittance center identification, other information useful for remittance center identification, preferred credit form (paper or electronic), preferred remittance advice form (paper or electronic), a deposit account to which payments may be electronically credited, electronic links for delivery of electronic credits and/or electronic remittance advice (described below), and/or any other information useful in the remittance processing associated with a particular payee. A managed payee 112 provides remittance information to the payment service provider 102. The received remittance information is typically stored in a managed payee database (also referred to as a managed merchant database). An electronic payee is a managed payee about whom a payment service provider maintains information enabling remittance to be issued electronically. A merchant is a payee that issues bills for services rendered or goods purchased. A merchant can be an unmanaged merchant a managed merchant, or an electronic merchant.

Remittance advice is a description of a credit that allows proper payment posting to a specific account, or sub-account, in a payee's Accounts Receivable ledger. Remittance advice may be coupled with an instrument used to accomplish the credit (e.g., information printed in a memo field on a check or draft, or information included in a field in an electronic funds transfer file transmitted over a network linking financial institutions). Alternatively, remittance advice may be somewhat decoupled from the credit, such as a paper document delivered to a payee separate from the delivery of a credit, or an electronic file transmitted directly to the payee separate from the delivery of the credit. Remittance advice may include information identifying a payor, information identifying the payor's account with the payee, a payment account, and/or other information useful to describing a credit for proper payment processing.

Also shown in FIG. 1 are one or more unmanaged payees 110. Unlike a managed payee 112, an unmanaged payee 110 is a payee about whom a payment service provider 102 does not receive updates regarding remittance information from the unmanaged payee 110 to maintain accurate and up-to-date remittance information. In other words, there is no formal relationship between the service provider and the unmanaged payee to aid in the handling of remittance. Unlike managed payees 112, unmanaged payees 110 do not provide a variety of remittance information to the payment service provider 102.

Also shown in FIG. 1 are one or more financial institutions 114. At least one of the financial institutions 114 maintains one or more demand deposit accounts belonging to the payment service provider 102. In one embodiment of the invention, a financial institution 114 maintaining a payment service provider 102 account communicates with the payment service provider 102 via a network, depicted here as one of the family of networks represented by network 106. However, not all embodiments of the invention require such electronic communication. Moreover, other embodiments of the invention do not require that each financial institution 114 communicate via the network 106. Also, each of the subscribers 104 is associated with at least one respective demand deposit account maintained at one of the financial institutions 114. Furthermore, each of the unmanaged payees 110 and the managed payees 112 may be associated with at least one respective demand deposit account maintained at one of the financial institutions 114.

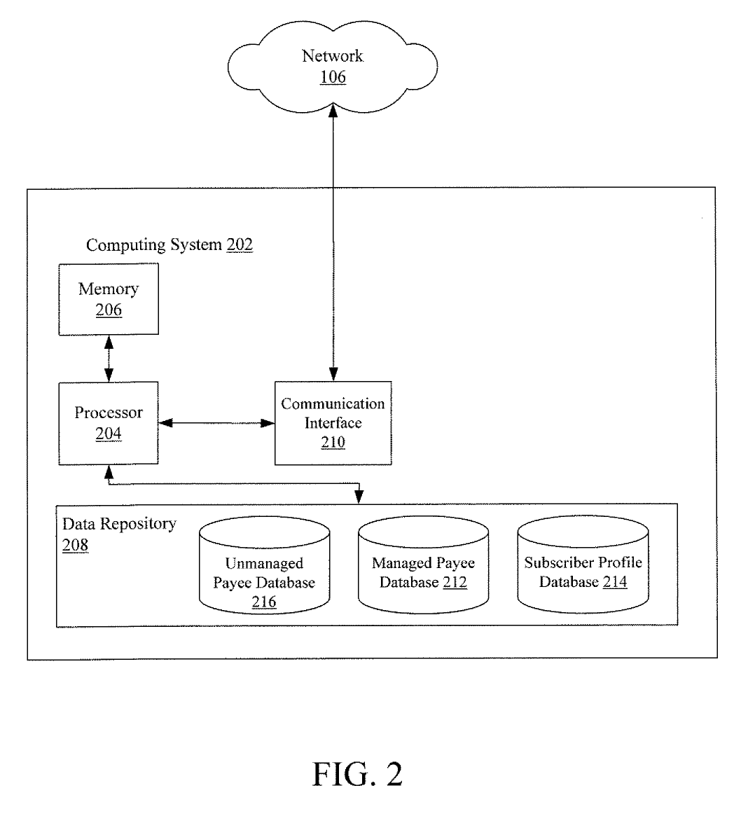

FIG. 2 is a diagram of a payment service provider computing system in accordance with an embodiment of the invention. According to the embodiment of the invention shown in FIG. 2, the computing system 202 includes at least one processor 204 configured to execute programming instructions stored in at least one memory 206. The computing system 202 also includes a data repository 208 configured to store data necessary to provide the payment service. Also shown in FIG. 2 is at least one communication interface 211 for transmitting and receiving data at least via the network 106. As desired, a communication interface 210 also transmits and/or receives data via one or more networks other than the network 106.

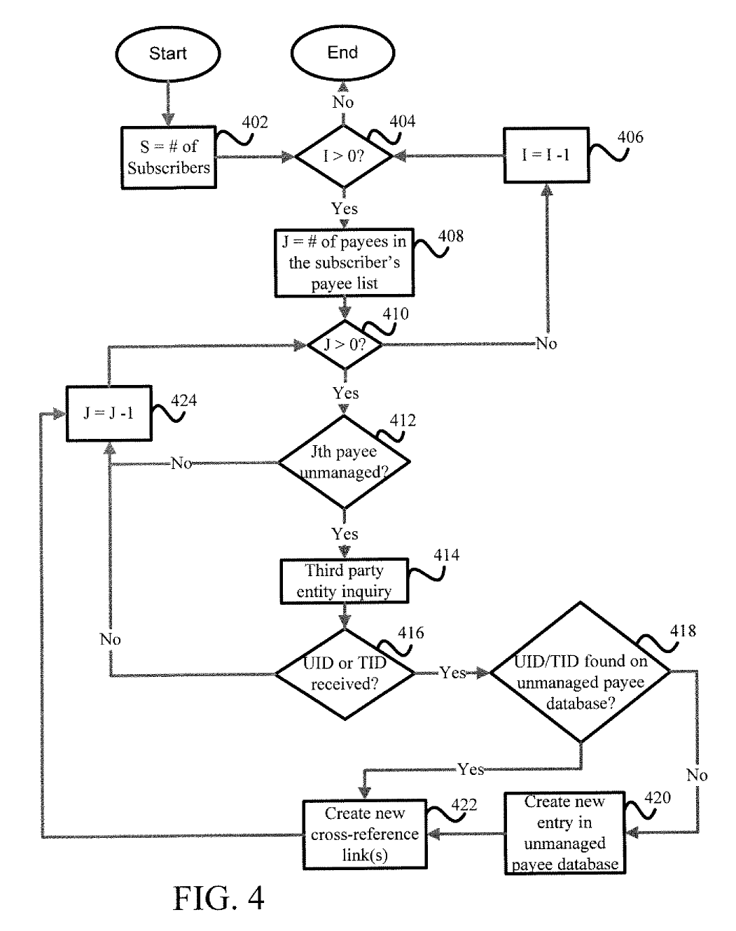

The data repository 208 includes a managed payee database 212 that stores information identifying and associated with managed payees. A managed payee database 212 includes information identifying each managed payee known to a payment service provider, along with the information received from each managed payee. In an example embodiment of the invention the data repository 208 may also include an unmanaged payee database. Several embodiments of the invention may create and/or maintain a database of “normalized” or “authoritative” information associated with unmanaged payees. Such a database allows changes deemed “authoritative” to be picked up for all subscribers associated with the payee. The creation and function of the unmanaged payee database will be described in further detail below with reference to FIG. 4.

The data repository 208 also includes a subscriber database 214 that stores information identifying and associated with subscribers. The subscriber database 214 may include, for each subscriber, a subscriber's name, address, funding account information, profile information, payee lists, bills, pending and/or historical payments and/or other data associated with a particular subscriber. In one embodiment of the invention, the subscriber database 214 may also include a subscriber's phone number and e-mail address. Also, as desired, the subscriber database 214 may include other types of information associated with a subscriber. Other information utilized in payment processing may also be stored in the data repository 208.

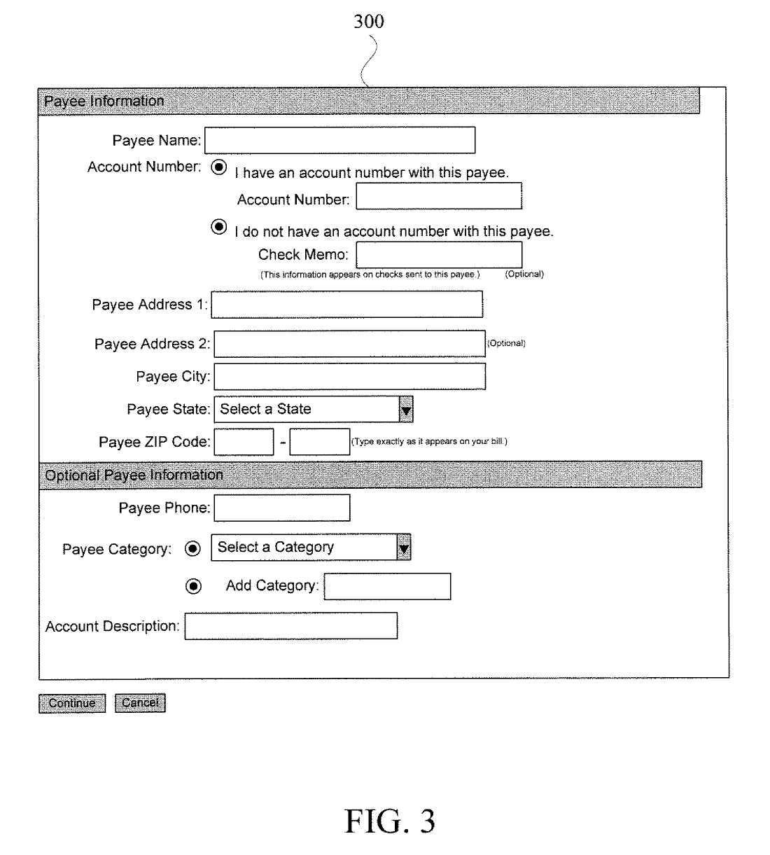

FIG. 3 depicts a user interface for payee set-up and/or modification. As shown in the payee information interface 300 of FIG. 3, a subscriber provides information identifying a payee. Such information may include a payee name, a payee account number (if applicable), payee address and/or other information capable of identifying the payee and allowing for future transactions which that payee. Beyond this basic information that may be used to identify and contact a payee, there could be, as desired, provisions for entering additional information, such as a payee telephone number, payee e-mail address (not shown in FIG. 3), payee category (e.g., utility, vendor, bank etc.), account type, and/or an account description or comment. Many of these fields may be considered optional.

FIG. 4 is a flowchart directed to creating a new unmanaged payee database from preexisting unmanaged payee data distributed throughout subscriber data in accordance with an embodiment of the invention. FIG. 4 depicts processing to ripple through existing payee lists to create a new unmanaged payee database. The process begins at step 402 in which an iteration limit “I” is set to the number of subscribers in the system.

Next, step 404 is invoked to check whether there are subscribers remaining to process. If there are no additional subscribers to process, the creation of the unmanaged payee database is complete and processing ends. If there are additional subscribers to process, processing of the “Ith” subscriber's payee list continues with step 408.

In step 408, an iteration limit “J” is set to the number of payees in the “Ith” subscriber's payee list. Next, step 410 is invoked to check whether there are remaining payees to process. If there are no remaining payees to process, processing of the “Ith” subscriber's payee list is complete and processing continues with step 406, in which the counter, I, is decremented. Then control returns to step 404 to determine if there are any more subscribers to process.

If there are additional payees to process, then step 412 is invoked to check whether the “Jth” payee in the payee list is an unmanaged payee. This determination may include verifying a managed/unmanaged indicator in the payee list entry, looking for a link to a managed merchant database entry, or, at the other end of the spectrum, it may involve attempting merchant identification anew based on current contents of the “Jth” payee list entry. If the “Jth” payee is determined to be a managed payee, further processing of that entry is skipped, and step 424 is invoked in which “J” is decremented in and control returns to step 410 to determine if there are additional payee list entries to process.

If it is determined that the “Jth” payee is unmanaged in step 412, then step 414 is invoked in which a set of values from the “Jth” payee list entry is sent to a third party identity service. The values sent to the third party identity service may include one or more of payee name, payee address, payee telephone number, payee tax identifier, payee email ID, or other available information associated with a payee. The third party identity service is a commercial service that attempts to match the supplied information to an entity in its comprehensive data repository. If the service finds a match, it returns either a definitive universal identifier (UID) or a temporary identifier (TID), either of which is unique across all entities. In addition, the service also returns a “best-known” address for the entity, which may differ from that supplied. It is possible that the service cannot find a match and is unable to return either an LID or TID.

Step 416 determines whether an UID or TID with a “best-known” address was received from the third party identity service. If an LID or TID with a “best-known” address was not received, nothing further can be done with the current unmanaged payee (i.e., it cannot be added in an authoritative manner to the unmanaged payee database, or matched against an existing entry). Thus, step 424 is invoked where counter “J” is decremented, and control returns to step 410 to determine if there are additional payee list entries to process. Ultimately the unmanaged payee database will contain all unmanaged payees. In an alternative embodiment of the invention, if no UID or TID is received from the third party identity service a value corresponding to an UID or TID could be locally created and assigned to the unmanaged payee instead of skipping to the next unmanaged payee. Most, if not all, entries will contain an UID or TID returned from the third party identity service, though some entries may contain a locally created equivalent to the UID or TID. The algorithm for creating such a local value may ensure that there would be no conflict with historic or future values received from the third party identity service. This could be achieved by, for instance, using a prefix that the third party identity service would not use, or alternatively, locating a prefix in character positions that extend the field length beyond that of the value returned by the identity service.

For example, if the identity service returns a 12-character numeric string, the field could be extended to 13 characters, with a leading “0” if an UID or TID from the third party identity service is used and some alternate character if a value is locally created. In addition, the algorithm for creating a local value should not be such that the same unmanaged payee in two different payee lists could produce the same value. In an alternative embodiment of the invention, the payee information and the locally assigned values may be provided to the third party identity service, so that the third party identity service's existing matching algorithms may be leveraged to match against these values as well. Additional local value creation techniques may be appreciable by one of ordinary skill in the art. Once a value is locally created and assigned, processing can continue with step 418.

If an UID or TID with a “best-known” address was received in step 416 or a value was locally created and assigned, then step 418 is invoked to determine whether the UID or TID already exists on the unmanaged payee database (e.g., as a result of processing another subscriber's payee list). If the UID or TID already exists on the unmanaged payee database, then step 422 is invoked, where a cross-reference link is added to the current “Jth” payee list entry and possibly also to the entry found in the unmanaged payee database.

If the UID or TID does not already exists on the unmanaged payee database, then step 420 is invoked to create a new entry in the unmanaged payee database This entry would contain at least the UID or TID and the “best-known” address received from the third party identity service. In one embodiment of the invention, the address received from the third party identity service is treated as better than any historical data in payee list entries. In an alternative embodiment of the invention, it may be possible to determine when the payee address in the “Jth” payee list entry was last modified, and if that is more recent than a predetermined time period (e.g., a number of days since the last modification), the address may be considered more current for use in remittance processing. Step 422 is then invoked, in which the UJID or TID is added to the “Jth” payee list entry. This allows the service provider to pick up the “authoritative” information from the unmanaged payee database when processing a payment request to this unmanaged payee.

However, the subscriber-supplied information in the payee list entry is neither replaced nor deleted. In addition, the “Ith” subscriber identifier may be added to a list of subscribers associated with the unmanaged payee in the UID or TID entry just found or created. This facilitates quick determination of how many, and which, subscribers have identified this unmanaged payee as a payee. Step 422 may not be completely optional, as this is also where the UID or TID is added into the “Jth” payee list entry.) Next, step 424 is invoked where “J” is decremented and control returns to step 410 to determine if there are additional payee list entries to process. If there are no additional payee list entries to process, then the unmanaged payee database creation process is completed.

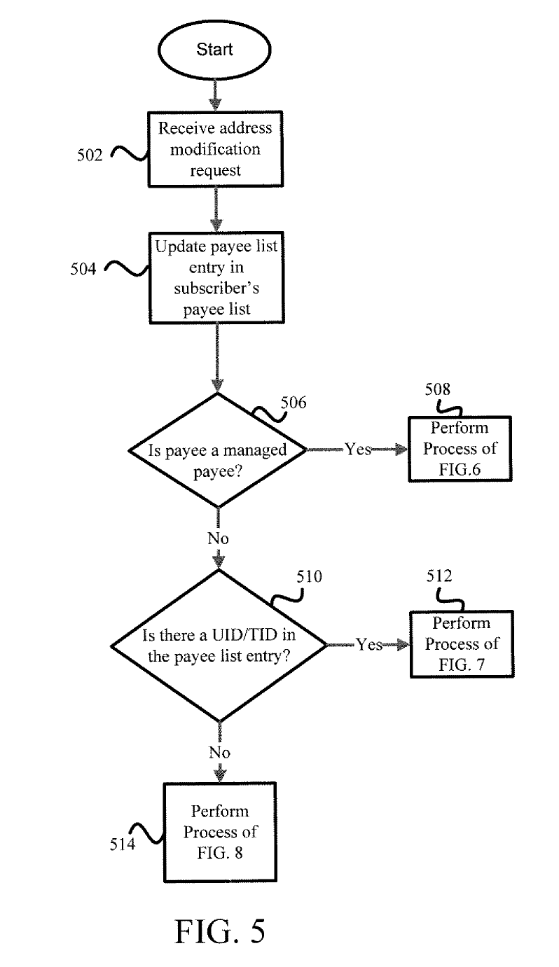

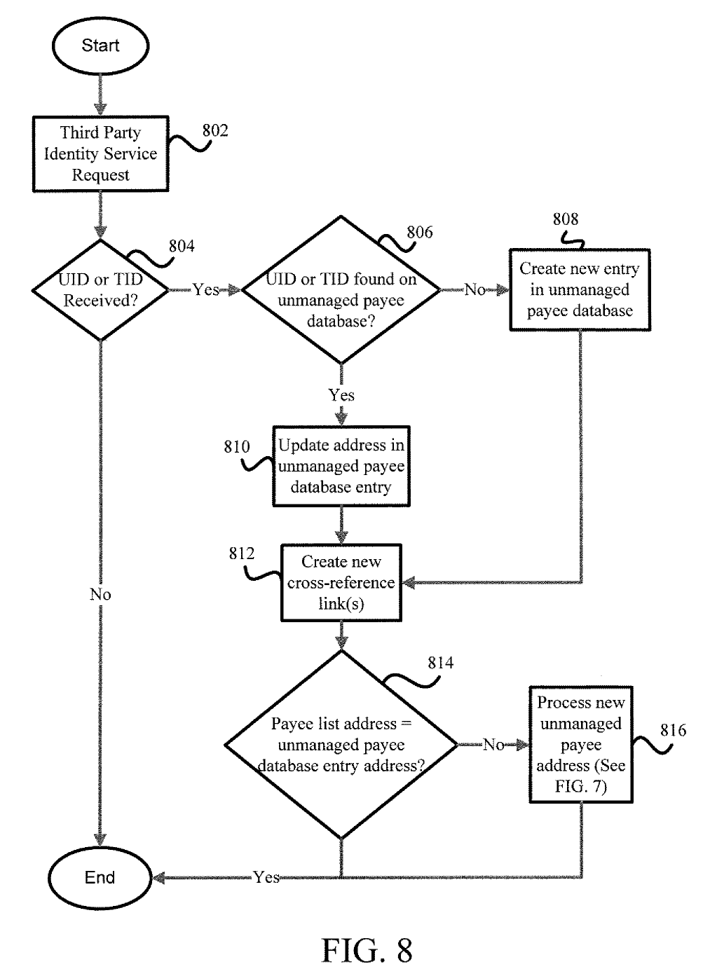

FIGS. 5 is a flowchart of the overall process for determining how to hold or propagate a change of address for an established payee when receiving an address modification request in accordance with an embodiment of the invention. As shown in FIG. 5, the modification process starts at step 502, in which a payee address modification request for an established payee is received from a subscriber. As a payment request is received, it either refers to a payee by reference (via a payee list identifier) or in a qualified manner (e.g., providing details such as name and address, which would triggers the creation of a new payee list entry through the process described below with reference to FIG. 8. In either case, the existing mapping to a managed payee or the mapping to an unmanaged payee on a new unmanaged payee database (via an UID or TID) will allow the “best-known” address associated with the payee to be used, which may be different than the address supplied by the subscriber and/or present in the payee list entry, As updates are made to the database addresses, these are then automatically picked up for subsequent payments on behalf of any subscribers linking to these entries. The modification request of step 502 may be either an “add payee” or a “change payee” transaction received from (or on behalf of) a subscriber.

Next in step 504, for an “add payee” transaction, a new payee list entry for the new payee is created in the subscriber's payee list, capturing the provided information (payee name, payee address, etc.). Alternatively, in step 504, for a “change payee” transaction, an existing payee list entry in the subscriber's payee list is updated with the provided information.

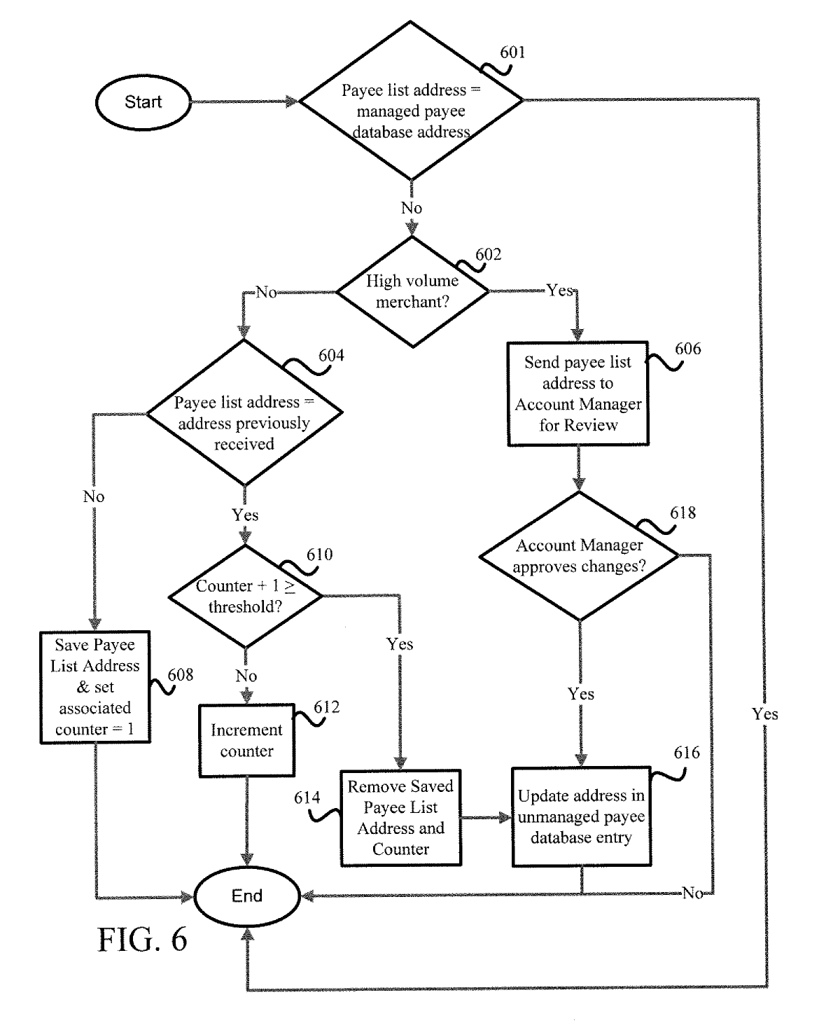

Step 506 is then invoked to determine if the payee is a managed payee. This determination may include verifying a managed/unmanaged indicator in the payee list entry, looking for a link to a managed merchant database entry, or, at the other end of the spectrum, it may involve attempting merchant identification anew based on current contents of the payee list entry. There are a number of ways that merchant identification could be done, such as running the received address data through an acquired software utility (e.g., Code One from Group One, Inc.) to generate a 9- or 11-digit zip code, then use this extended zip code to locate a match on the managed payee database. If the payee is a managed payee, step 508 is invoked to begin the process of updating the managed payee database as described in FIG. 6 below. This managed payee processing in particular includes new processing for when the received address does not match the authoritative address on the managed payee database.

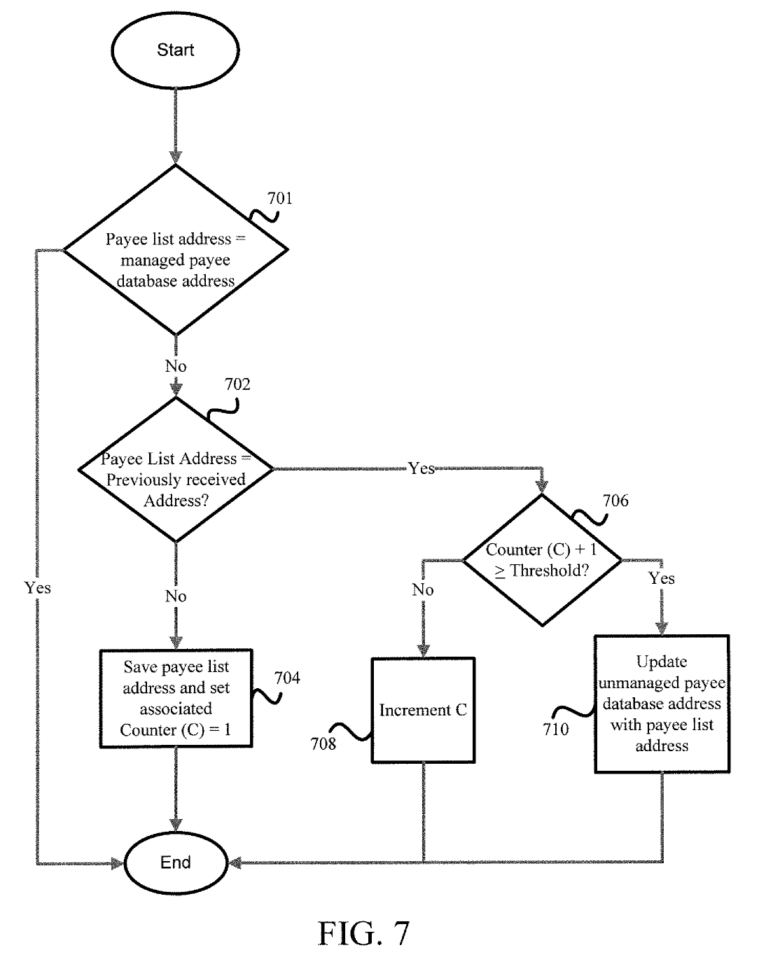

If, in step 506, it was determined that the payee is not a managed payee, then step 510 is invoked to determine whether the payee list entry contains an UID or TID. If one of these values is found, it may be used as a link to an entry on the unmanaged payee database, and processing continues with step 512, in which the process of updating the unmanaged payee database described in FIG. 7 is performed.

If no UID or TID was found in step 510, then the unmanaged payee has not yet been successfully entered or matched to the unmanaged payee database, and step 514 is invoked, in which the process of adding the unmanaged payee to the unmanaged payee database described in FIG. 8 is performed.

FIG. 6 is a flowchart directed to the processing of a subscriber-supplied address for a managed payee in accordance with an embodiment of the invention. The diagram depicts the managed payee processing of step 512 of FIG. 5 in further detail, with particular focus on what happens when the subscriber-supplied payee address does not match the currently authoritative address on the managed payee database.

The process shown in FIG. 6 involves comparing the address supplied by the subscriber to the address in the managed payee database. First, step 601 is invoked to determine whether the address supplied by the subscriber (in the just-created payee list entry) matches the currently authoritative address in the matched managed payee database entry. Because subscriber-supplied address information for the same entity may vary widely in format or content, some normalization of data and/or generation of a database lookup key may be required before the process can definitively determine whether the subscriber-supplied address matches the managed payee database entry. This might, for instance, require the generation of a 9 or 11-digit zip code through a utility like Code One and a comparison on the basis of the extended zip codes. Code One is a software product from Group One, Inc. that generates an 11-digit zip code from supplied address information. If the two addresses are determined to be the same in step 601, the process of FIG. 6 ends.

In the case of a managed payee relationship, the managed payee may proactively provide notification of an address change. There are several options as to how this could be processed. First, the address change from the managed payee may be treated as authoritative and accepted without question, automatically replacing the address in the appropriate managed payee database entry. Second, the address change may be treated as equivalent to a subscriber-supplied payee address modification for a “high volume” merchant, and may cause the processing for substituting the received address for the payee list address, shown in FIG. 6 and described below, to be executed. Third, the address change may be treated as equivalent to a subscriber-supplied payee address modification for a non-“high volume” merchant and may cause the processing for substituting the received address for the payee list address, also show in FIG. 6 and described below, to be executed. In alternative embodiments of the invention, the payment service provider may determine whether the managed payee in question is a “high-volume” merchant whether the address change is supplied by the subscriber or managed payee.

Referring back to the embodiment of FIG. 6, if the two addresses are determined to be different, processing continues with step 602, in which it is determined if the managed payee is also a “high volume” merchant. In an example of an embodiment of the invention, high volume merchants are a predefined set of managed payees, with an indicator in the database entry.

If the managed payee is not a “high volume” merchant, then step 606 is invoked, in which the new address is saved in a list of addresses that have been received and considered for this payee and is sent to the account manager for that merchant. The account manager performs research to determine whether the new address should be adopted or not. Step 618 is then invoked to determine whether the account manager approves the change or not. If the account manager has not approved the changes, the processing of a subscriber-supplied managed payee address that does not match the previously known address stored in the matching managed payee database entry terminates. If the change is approved by the account manager, then step 616 is invoked, in which the address currently in the managed payee database is replaced with the new address (potentially normalized) that had been received from the subscriber. At this point the processing of a subscriber-supplied managed payee address that does not match the previously known address stored in the matching managed payee database entry terminates.

If it was determined that the managed payee is not a “high volume” merchant in step 602, then step 604 is invoked to determine whether the newly received payee address matches any address previously received from another subscriber that has been stored in association with the managed payee database entry. Again, this match may require normalization of data and/or matching on the basis of an extended zip code. If the current address is not found, step 608 is invoked, in which the current address is stored in association with the current managed payee database entry, and a new counter associated with this “pending” address is created and set to 1. At this point the processing of a subscriber-supplied managed payee address that does not match the previously known address stored in the matching managed payee database entry terminates.

If the current payee address was found to match one of the addresses stored, then step 610 is invoked to determine whether the counter associated with the pending address, incremented by 1 to include the current subscriber's citation of this address, is greater than or equal to some threshold value (N). If the sum of the previous counter value+1 is still less than the threshold value, the step 612 is invoked, in which the counter is incremented. At this point the processing of a subscriber-supplied managed payee address that does not match the previously known address stored in the matching managed payee database entry terminates.

If the sum of the previous counter value+1 is greater than or equal to the threshold value, then there have been enough citations of this address to cause it to be adopted as the new authoritative payee address, and step 614 is invoked. Other methods of tracking the number of subscriber submissions of a particular address associated with a particular payee may be appreciable by one of ordinary skill in that art. In step 614, the pending address and its associated counter are deleted. Next, step 616 is invoked, in which the managed payee database entry is updated with the new payee list address (potentially normalized). At this point the processing of a subscriber-supplied managed payee address that does not match the previously known address stored in the matching managed payee database entry terminates. In an alternative embodiment of the invention, the processing described above for “high volume” merchants may be performed for those merchants that are not “high volume,” and/or the processing described above for merchants that are not “high volume” may be performed for “high volume” merchants.

FIG. 7 is a flowchart directed to the processing of a subscriber-supplied unmanaged payee address that does not match the previously known address stored in the corresponding unmanaged payee database entry in accordance with an embodiment of the invention. If a payee cites an address change but submits an address that has already been considered authoritative no further processing is necessary. As shown in FIG. 7, the processing of a subscriber-supplied unmanaged payee address that does not match the “best-known” address in the corresponding unmanaged payee database entry begins at step 701.

Step 701 is invoked to determine whether the address supplied by the subscriber (in the just-created payee list entry) matches the currently authoritative address in the unmanaged payee database entry. Because subscriber-supplied address information for the same entity may vary widely in format or content, some normalization of data and/or generation of a database lookup key may be required before the process can definitively determine whether the subscriber-supplied address matches the unmanaged payee database entry. This might, for instance, require the generation of a 9 or 11-digit zip code through a utility like Code One and a comparison on the basis of the extended zip codes. Code One is a software product from Group One, Inc. that generates an 11-digit zip code from supplied address information. If the two addresses are determined to match, this further processing ends. If the two addresses are determined to be different, processing continues with step 702.

Step 702 determines whether the newly received payee address matches any address previously received from another subscriber that has been stored in association with an unmanaged payee database entry for further consideration. This match may require normalization of data and/or matching on the basis of an extended zip code, as described earlier. If the current address is not found, processing continues with step 704, in which the current address is stored in association with the current unmanaged payee database entry, and a new counter associated with this “pending” address is created and set to 1. At that point the processing of a subscriber-supplied unmanaged payee address that does not match the “best-known” address in the matching unmanaged payee database entry ends.

If a match for the newly received payee address was found among the “pending” addresses associated with the unmanaged payee database entry, then step 706 is invoked to determine whether the counter associated with the matched pending address, which is (or has previously been) incremented by 1 to include the current subscriber's citation of this address, is greater than or equal to a threshold value (T). This threshold is not necessarily the same as the previously described threshold value. If the counter value, which reflects the current subscriber citation of the address (e.g., previous counter value+1), is still less than the threshold value, then step 708 is invoked where the counter is incremented. At that point the processing of a subscriber-supplied unmanaged payee address that does not match the “best-known” address in the matching unmanaged payee database entry ends.

If the sum of the previous counter value+1 is equal to or greater than the threshold value, then there have been enough citations of this address to cause it to be adopted as the new authoritative payee address, and step 710 is invoked where the stored pending address and its associated counter are deleted and the unmanaged payee database entry is updated with the new address. At that point the processing of a subscriber-supplied unmanaged payee address that does not match the “best-known” address in the corresponding unmanaged payee database entry ends. Note that while the address in the unmanaged payee database entry is updated, and the payer's payee list entry points to this, the address in the payee list entry may not be updated.

In an alternative embodiment to the process shown in FIG. 7, the payment service provider may attempt to get a new “best-known” address from the third party identity service, rather than wait to receive a certain number of citations of a new address from subscribers to trigger changing the authority address on the unmanaged payee database. Moreover, in some embodiments, the third party identity service may not have to be solicited for updates, but will proactively provide them. In an alternative embodiment of the invention, the payment service provider may determine whether a third party identity service was accessed for the given UID or TID, and if that date was greater than some number of days ago, request updated information from the third party identity service for the UID or TID. Then, if a new address is received, the new address could update the current authority address, any matching pending address and counter could be removed, and further processing of the current payee address modification would continue only if it is different from the newly updated authority address.

FIG. 8 is a flowchart directed to the process of creating new unmanaged payee information in accordance with an embodiment of the invention. For example, the creation of new unmanaged payee information may occur when a subscriber adds a new payee. In an example of an embodiment of the invention, the first source of a new address is when a subscriber adds a new payee. The process begins at step 802, where a request is sent to a third party identity service. The request may be for one or more of a payee name, payee address, payee telephone number, payee tax identifier, payee email ID, or other available information associated with a payee.

Next, step 804 is invoked to determine whether an UID or TID (along with a “best-known” address) was received from the third party identity service. If not, nothing further can be done with the current unmanaged payee (i.e., it cannot be added in an authoritative manner to the unmanaged payee database, or matched against an existing entry), and processing ends. If a UID or TID was received from a third party service, then processing of the current payee (an unmanaged payee for which an UID or TID and “best known” address has been received) continues with step 806.

Most, if not all, unmanaged payee database entries will contain an UID or TID returned from the third party identity service. However, some entries may contain a locally created equivalent to the UID or TID. For instance, in an alternative embodiment of the invention not shown in the flow diagram of FIG. 8, if no UID or TID is received from the third party identity service, a value corresponding to an UID or TID could be locally created and assigned to the unmanaged payee. An algorithm for creating such a local value may ensure that there would be no conflict with historic or future values received from the third party identity service. In one embodiment of the invention, this could be achieved by using a prefix that the third party identity service would not use, or alternatively, locating a prefix in character positions that extend the field length beyond that of the value returned by the identity service.

For example, if the identity service returns a 12-character numeric string, the field could be extended to 13 characters, with a leading 0 if an UID or TID from the identity service is used and some alternate character if a value is locally created. In one embodiment of the invention, the algorithm for creating a local value should not be completely random because the same unmanaged payee in two different payee lists may produce the same value. In another embodiment of the invention, the payee information with the locally assigned values to the third party identity service so that third party identity service's existing sophisticated matching algorithm can be leveraged to match against these values. Additional local value creation techniques may be appreciable by one of ordinary skill in the art.

A locally created UJID or TID value should be replaced with a “real” UID or TID if one is returned later when another subscriber adds the same payee. Such functionality may require that when a “real” UID or TID is returned, the process to create a local value is also executed, where an attempt is made to find a match of the local value on the unmanaged payee database. If a match is found, then the data returned from the identity service (UID or TID and “best known” address) can replace prior values on the database.

Once a value is locally created and assigned, processing can continue with step 806. Step 806 determines whether the UID or TID already exists on the unmanaged payee database. If the UID or TID is not found on the unmanaged payee database, then step 808 is invoked where a new entry is created in the unmanaged payee database. This entry would include the UID or TID.

If the UID or TID is found on the unmanaged payee database, then step 810 is invoked, in which the “best-known” address in the matching entry on the unmanaged payee database is updated. The “best-known” address just received from the third party identity service updates a missing or different address in the unmanaged payee database entry as necessary and appropriate. If, as a result of the processing of the new unmanaged payee address (discussed in detail with reference to FIG. 7 above) the authoritative, “best-known” address had been updated to a payor-supplied value that had been submitted by multiple subscribers, then it may be desirable to not accept a payee address from the third party identity service for some period of time. While generally the data from the third party identity service is considered more authoritative than the data provided by subscribers, it is conceivable that subscribers may be more current, which may be evidenced by a plurality of subscribers providing the same update.

Once the address in the unmanaged payee database has been updated or added, then step 812 is invoked, where the UID or TID is added to the payee list entry. In one embodiment of the invention, this may support obtaining the “authoritative” information from the unmanaged payee database when processing a payment request directed towards this particular unmanaged payee. In another embodiment of the invention, the subscriber-supplied information in the payee list entry is neither replaced nor deleted. In an alternative embodiment of the invention, the subscriber identifier could be added to a list of subscribers associated with the unmanaged payee in the UID or TID entry just updated or created. Such cross-reference may facilitate quick determination of how many, and which, subscribers have identified this unmanaged payee as a payee. Another way to determine this information would be to search all payee lists for a particular UID or TID.

After step 812 is completed, step 814 determines whether the payee address in the payee list entry matches the “best-known” address present in the unmanaged payee database entry. If the addresses match, then the process ends. If the addresses do not match, then step 816 is invoked where the new unmanaged payee address is processed, which is discussed in detail with reference to FIG. 7 above.

For changes to existing payee list entries, the third party identity service may provide proactive notification of a change in the “best-known” address for a payee, assuming the identity service retains knowledge of UIDs previously sent to us. The address change would be received with the UID or TID, so it would be quite straightforward to look up the entry on the unmanaged payee database. Assuming the corresponding entry is found (i.e., it is possible that the unmanaged payee could become a managed payee and be removed from the unmanaged payee database), there are at least two options for processing the address change. First, the address change from the third party identity service may be treated as authoritative and accepted without question, replacing the existing “best-known” address in the unmanaged payee database entry. Second, the address change from the third party identity service may be treated as no more authoritative than a subscriber-supplied payee address modification, and processing of substituting the received address for the payee list address would be executed.

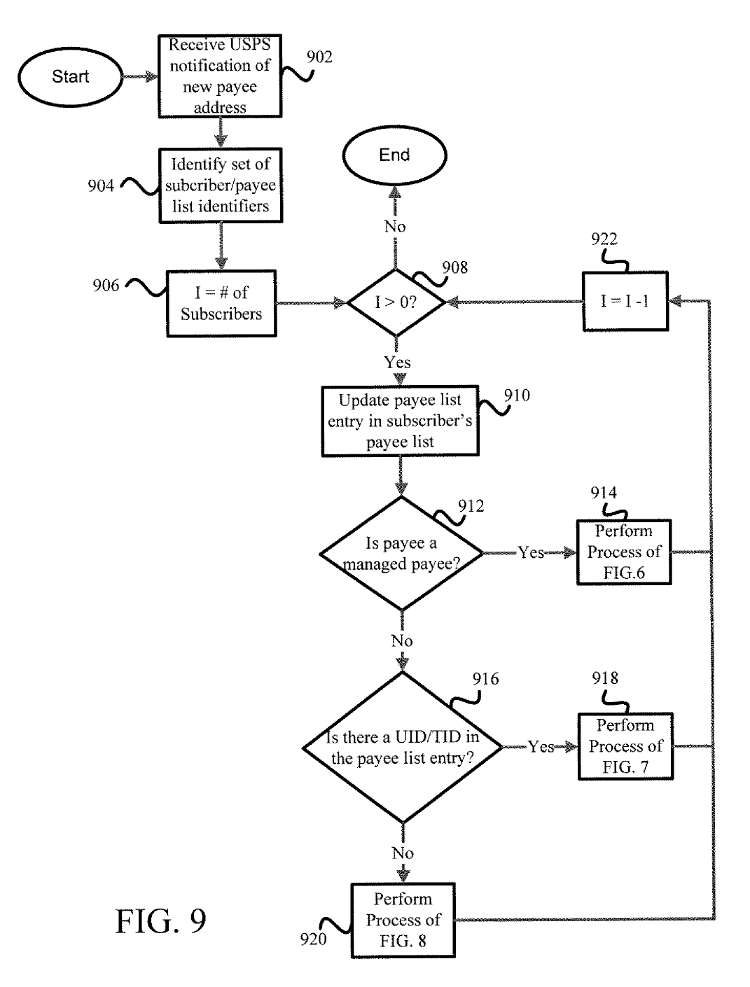

FIG. 9 is a flowchart directed to the processing of a change of address provided by a third party service, such as the United States Postal Service (USPS), in accordance with an embodiment of the invention. As shown in FIG. 9, processing a change of address notification provided by the postal service begins at step 902 in step 902 a change of address is received from the USPS in relation to a paper payment that was mailed. This will happen as a function of the payment service provider participating in the One Code service offered by the USPS. One Code is a service in which the mailer can provide a value (code) that is included in a “key line” or bar code on the envelope. The value can then be used by the sender to look up data for correction or for problem resolution processing. In association with a mailed paper payment, the payment service provider may provide a code that is associated with the payment and store the code in the payment history data repository. That payment, in turn, may be associated with a single payee as well as one or more subscribers (e.g., it may have been a consolidated payment).

Next, in step 904, the code is used to access the correct payment in the payment history table and from there determine the set of subscribers associated with the payment, and the payee list entry corresponding to the payee for each subscriber in the list. Step 906 is then invoked to set an iteration limit (I) to the number of subscribers identified in step 904. Then a processing loop is executed for each subscriber between steps 908 and 922. Step 908 determines if the counter is greater than zero indicating there are additional subscribers to process. If the counter is at zero, then processing ends.

If the counter is higher than zero, then step 910 is invoked where the “Ith” subscriber's payee list entry is updated with the address received from the USPS. Such functionality reflects an assumption that if the subscriber had sent the payment herself and received an address correction from the USPS, she would have taken notice of it for future payments, and thus the automated processing should perform the same on behalf of the subscriber. Alternatively, a slight variant of the subsequent processing could be performed without updating the payee list entry, thus using the USPS-received payee address instead of the payee list entry address.

Then processing continues with step 912 to determine if the payee is a managed payee. In one embodiment of the invention, the determination of step 912 may be as simple as verifying a managed/unmanaged indicator in the payee list entry, looking for a link to a managed merchant database entry, or, at the other end of the spectrum, it could involve attempting merchant identification anew based on current contents of the payee list entry. If the payee is a managed payee, the step 914 is invoked to begin the process of updating of the managed payee database as described in FIG. 6. Once that process is complete, step 922 is invoked to decrement the counter and process the payee information update for the next subscriber beginning at step 908.

If, in step 912, it was determined that the payee is not a managed payee, then step 916 is invoked to determine whether the payee list entry contains an UID or TIP. If one of these values is present, it is a link to an entry on the unmanaged payee database, and processing continues with step 918, in which the process of updating the unmanaged payee database described above with reference to FIG. 7 is performed. Once that process is complete, step 922 is invoked to decrement the counter and process the payee information update for the next subscriber beginning at step 908.

If no UID or TID was found in step 916, then this is an unmanaged payee that has not yet been successfully entered on (or matched to) the unmanaged payee database, and step 920 is invoked, in which the process of adding the unmanaged payee described above with reference to FIG. 8 is performed. Once that process is complete, step 922 is invoked to decrement the counter and process the payee information update for the next subscriber beginning at step 908. If the counter has reached zero, then the processing ends.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving a first instance of a type of remittance information associated with a payee;
identifying a database entry associated with the payee, wherein the database entry includes a second instance of the type of remittance information;
incrementing a counter associated with the first instance of the type of remittance information, wherein the incremented counter value reflects the number of times the first instance of the type of remittance information has been received;
detecting that a threshold value associated with the counter has been reached; and
upon detecting that the threshold value has been reached, replacing the second instance of the type of remittance information in the database entry with the first instance of the type of remittance information.

2. The method of claim 1, further comprising storing the incremented counter value.

3. The method of claim 1, further comprising normalizing the first instance of the type of remittance information prior to replacing the second instance of the type of remittance information in the database entry with the first instance of the type of remittance information.

4. The method of claim 1, wherein replacing the second instance of the type of remittance information in the database entry with the first instance of the type of remittance information includes storing the first instance of the type of remittance information in a payee list entry associated with a subscriber and the payee.

5. The method of claim 1, further comprising:
storing the first instance of the type of remittance information in association with the database entry as a potential replacement for the second instance of the type of remittance information.

6. The method of claim 1, wherein the first instance of the type of remittance information includes address information associated with the payee.

7. The method of claim 1, further comprising:
receiving a payment request, wherein the payment request identifies the payee; and
generating payment to the payee using one of the first instance of the type of remittance information and second instance of the type of remittance information to generate payment to the payee, wherein the first instance of the type of remittance information is used if the processing occurs after the replacing of the second instance of the type of remittance information in the database entry, and wherein the second instance of the type of remittance information is used if the processing occurs before the replacing of the second instance of the type of remittance information in the database entry.

8. The method of claim 7, wherein the first instance of the type of remittance information is received from one subscriber and the payment request is received from another subscriber.

9. The method of claim 1, wherein the first instance of the type of remittance information is received from a first source, and further comprising:
prior to receiving the first instance of the type of remittance information from the first source, receiving the first instance of the type of remittance information from a second source and incrementing the counter associated with the first instance of the type of remittance information.

10. The method of claim 9, wherein each of the first source and the second source is an external identity service, a subscriber, the payee, or a postal service, and wherein the first source is different from the second source.

11. The method of claim 1, further comprising one of (i) receiving a universal identifier associated with the payee and (ii) creating a universal identifier associated with the first instance of the type of remittance information.

12. The method of claim 11, wherein identifying a database entry associated with the payee is based upon the universal identifier.

13. The method of claim 11, wherein receiving a universal identifier associated with the payee includes obtaining a universal identifier from a payee list entry associated with the payee.

14. The method of claim 1, wherein the payee is one of a managed payee or an unmanaged payee.

15. The method of claim 1, further comprising submitting the first instance of the type of remittance information to an account manager associated with the payee; and
receiving approval of the first instance of the type of remittance information from the account managers wherein replacing the second instance of the type of remittance information in the database entry with the first instance of the type of remittance information occurs subsequent to receiving approval of the first instance of the type of remittance information from the account manager.

16. The method of claim 1, wherein the first instance of the type of remittance information is received from a postal service in association with a code, and further comprising:
identifying a payment using the code;
identifying a set of one or more subscribers associated with the payment; and
for each of the subscribers in the set, storing the first instance of the type of remittance information in a payee list entry associated with the subscriber and the payee.

17. The method of claim 1, further comprising receiving, from a third party service, a universal identifier or a temporary identifier associated with one of the first and second instance of the type of remittance information.

18. A system comprising:
a database, wherein the database includes a plurality of database entries; and
a processor, in communication with the database, wherein the processor is configured to execute software instructions for:
receiving a first instance of a type of remittance information associated with a payee,
identifying, in the database, a database entry associated with the payee, wherein the database entry includes a second instance of the type of remittance information,
incrementing a counter associated with the first instance of the type of remittance information, wherein the incremented counter value reflects the number of times the first instance of the type of remittance information has been received,
detecting that a threshold value associated with the counter has been reached, and
upon detecting that the threshold value has been reached, replacing the second instance of the type of remittance information in the database entry with the first instance of the type of remittance information.

19. The system of claim 18, wherein the processor is configured to execute additional software instructions for:
storing the incremented counter value in the database.

20. The system of claim 13, wherein the processor is configured to execute additional software instructions for:
normalizing the first instance of the type of remittance information prior to replacing the second instance of the type of remittance information in the database entry with the first instance of the type of remittance information.

21. The system of claim 18, wherein the software instructions for replacing the second instance of the type of remittance information in the database entry with the first instance of the type of remittance information include storing the first instance of the type of remittance information in a payee list entry associated with a subscriber and the payee.

22. The system of claim 18, wherein the processor is configured to execute additional software instructions for:
storing the first instance of the type of remittance information in association with the database entry as a potential replacement for the second instance of the type of remittance information.

23. The system of claim 18, wherein the first instance of the type of remittance information includes address information associated with the payee.

24. The system of claim 18, wherein the processor is configured to execute additional software instructions for:
receiving a payment request, wherein the payment request identifies the payee, and
generating payment to the payee using one of the first instance of the type of remittance information and second instance of the type of remittance information to generate payment to the payee, wherein the first instance of the type of remittance information is used if the processing occurs after the replacing of the second instance of the type of remittance information in the database entry, and wherein the second instance of the type of remittance information is used if the processing occurs before the replacing of the second instance of the type of remittance information in the database entry.

25. The system of claim 24, wherein the first instance of the type of remittance information is received from one subscriber and the payment request is received from another subscriber.

26. The system of claim 18, wherein the first instance of the type of remittance information is received from a first source, and wherein the processor is configured to execute additional software instructions for:
prior to receiving the first instance of the type of remittance information from the first source, receiving the first instance of the type of remittance information from a second source and incrementing the counter associated with the first instance of the type of remittance information.

27. The system of claim 26, wherein each of the first source and the second source is an external identity service, a subscriber, the payee, or a postal service, and wherein the first source is different from the second source.

28. The system of claim 18, wherein the processor is configured to execute additional software instructions for one of (i) receiving a universal identifier associated with the payee and (ii) creating a universal identifier associated with the first instance of the type of remittance information.

29. The system of claim 28, wherein identifying a database entry associated with the payee is based upon the universal identifier.

30. The system of claim 28, wherein receiving a universal identifier associated with the payee includes obtaining a universal identifier from a payee list entry associated with the payee.

31. The system of claim 18, wherein the database is one of a managed payee database or an unmanaged payee database.

32. The system of claim 18, wherein the payee is one of a managed payee or an unmanaged payee.

33. The system of claim 18, wherein the processor is configured to execute additional software instructions for:
submitting the first instance of the type of remittance information to an account manager associated with the payee, and
receiving approval of the first instance of the type of remittance information from the account manager, wherein replacing the second instance of the type of remittance information in the database entry with the first instance of the type of remittance information occurs subsequent to receiving approval of the first instance of the type of remittance information from the account manager.

34. The system of claim 18, wherein the first instance of the type of remittance information is received from a postal service in association with a code, and wherein the processor is configured to execute additional software instructions for:
identifying a payment using the code,
identifying a set of one or more subscribers associated with the payment, and
for each of the subscribers in the set, storing the first instance of the type of remittance information in a payee list entry associated with the subscriber and the payee.

35. The system of claim 18, wherein the processor is configured to execute additional software instructions for:
receiving, from a third party service, a universal identifier or a temporary identifier associated with one of the first and second instance of the type of remittance information.

36. A system comprising:
a means for receiving a first instance of a type of remittance information associated with a payee;
a means for identifying a database entry associated with the payee, wherein the database entry includes a second instance of the type of remittance information;
a means for incrementing a counter associated with the first instance of the type of remittance information, wherein the incremented counter value reflects the number of times the first instance of the type of remittance information has been received;
a means for detecting that a threshold value associated with the counter has been reached; and
a means for replacing the second instance of the type of remittance information in the database entry with the first instance of the type of remittance information upon detecting that the threshold value has been reached.
